(19) United States
(12) Patent Application Publication
(10) Pub. No.: US 2009/0174120 A1
(43) Pub. Date: Jul. 9, 2009

(54) Injection Molding Apparatus With Plasma Generator, and Method for Injection Molding and Surface Processing

(75) Inventor: Hideo Sugai, Aichi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NATIONAL UNIVERSITY CORPORATION NAGOYA UNIVERSITY, Nagoya-shi, Aichi (JP)

(21) Appl. No.: 11/920,540

(22) PCT Filed: May 15, 2006
(86) PCT No.: PCT/JP2006/309663

§ 371 Date: Feb. 11, 2009

(30) Foreign Application Priority Data
May 19, 2005 (JP) 2005-146682

(51) Int. Cl. B29C 45/00; B29C 45/26; B29C 45/16; B29C 59/14

(52) U.S. Cl. 264/446; 425/174.4

(57) ABSTRACT

[Object] To provide an injection molding apparatus with a plasma generator, using no high-frequency power.

[Solving means] Injection molding is performed as shown in 1.A, and a molded article P is cooled to solidify. Then, as shown in 1.B, a second mold 200 is moved by 1 to several millimeters using a jack 120, to thereby form a space S. In this case, a gas inlet port 132 and an exhaust outlet 142 are opened with respect to the space S by the movement of the second mold 200, so that a gas inlet pipe 131, the space S, and an exhaust pipe 141 communicate with one another. These gas inlet pipe 131, space S, and exhaust pipe 141 are kept airtight by an O-ring 201 of the second mold 200. Next, from the airtight space S, air is exhausted using an exhaust device 140, and then a gas for plasma processing is supplied from the gas supply portion 130 into the space S. Thereafter, upon supply of microwaves to microwave antennas 160 via waveguides 150, an electric discharge by the microwaves occurs and gas plasma occurs, in the space S.

### TECHNICAL FIELD

The present invention relates to an apparatus and a method for injection molding during which surface processing is performed by using a plasma gas.

### BACKGROUND ART

Because plastic materials allow products of various shapes to be produced at low costs using injection molding methods, they are extensively used in the industrial field. Also, since plastics have advantages of being lightweight and easy to recycle, e.g., studies of replacing metal materials or glass materials for automobiles, electric appliances and the like, with plastics, are underway.

For example, the resinification of windowpanes of an automobile allows the reduction in fuel consumption due to the weight saving of the automobile body and the decrease in environment load, and enables the reduction in manufacture cost by integral molding. For example, Europe has a plan to resinify 3 to 5% of windowpanes of automobiles. This “resinification” includes a method in which a plastic film is sandwiched between laminated glass.

Since the plastic material is inferior to glass in the resistance to scratch, the resistance to ultraviolet radiation and the like, reinforcing the surface of plastic material with a thin-film coating has come into a task. Currently-conducted techniques described below each have a drawback. First, a system in which a hard coat film is applied onto the surface of a resin causes peeling of the film off the substrate. Also, a system in which a plastic film is sandwiched between two pieces of glass raises a problem of incurring corrugations. In this way, the “resinification” of glass involves problems. For now, what uses resin as a window material are limited to a sun-roof, and quarter glass, which is neither opened nor closed.

As a technique allowing surface modification of resin to be performed at a low temperature, plasma processing holds a significant promise. For example, Patent Document 1 discloses a technique for performing plasma processing, with molds for injection molding still used.

[Patent document 1] JP2994878

The outline of the technique in Patent Document 1 is as follows. Molten resin is injected into a mold cavity to fill it, and is cooled to solidify. Next, a mold is slightly opened, and a space is formed between a molded article and one of the two parts of the mold. After the space has been evacuated, a high-frequency power of 13. 56 MHz is applied between the two mold parts, and plasma is generated in the space. Then, a reactive gas corresponding to surface processing is introduced into the space to thereby subject the molded article to surface processing. Thereafter, electric discharge is stopped, and after the space has been returned to the atmospheric pressure, the molded article is taken out.

### DISCLOSURE OF INVENTION

### Problems to be Solved by the Invention

Patent Document 1 has the following problem. When the high-frequency power is applied between the two mold parts, if one of them is grounded, the other must be potentially floated from the ground, and therefore, it is necessary to shield electromagnetic waves emitted from the mold part that is potentially floated from the ground. This is because, unless the electromagnetic waves are shielded, they cause disturbances to surrounding devices such as a control device. In this case, a grounded metal body covering the entire injection molding apparatus is required.

When the grounded metal body is provided, if the mold is larger than several tens of centimeters, a floating capacitance between the grounded metal body and the mold part that is potentially floated from the ground becomes high, so that it is difficult to achieve impedance matching between a high-frequency power source and a load.

When a resin molded article is in contact with the mold part that is potentially floated from the ground, an auto-bias of several hundreds of volts occurs on the surface of the resin molded article, and the resin surface is roughened by strong ion impacts, so that a coating film may suffer damage.

The present invention has been made to solve the above-described problem.

### Means for Solving the Problems

An injection molding apparatus with a plasma generator according to the first aspect of the present invention includes means for fixing two molds, with a space made between one of the two molds and a molded article, after injection molding has been performed; at least one waveguide formed in at least one of the two molds; a microwave antenna that is connected to the at least one waveguide and that radiates microwaves into the space; exhaust means that exhausts air from the space to thereby hold a predetermined degree of vacuum in the space; and means for introducing a gas for processing the surface of the molded article, into the space between the at least one mold and the molded article, whereby plasma of the gas is allowed to be generated in the space.

The injection molding apparatus with a plasma generator according to the second aspect is characterized in that the at least one waveguide is filled with a dielectric material, in the injection molding apparatus with a plasma generator according to the first aspect.

The injection molding apparatus with a plasma generator according to the third aspect of the present invention is characterized in that the means for fixing the two molds can make the space on either side of the molded article, and that the exhaust means and the means for introducing the gas can operate on the space made on either side of the molded article.

The injection molding apparatus with a plasma generator according to the fourth aspect of the present invention is characterized in that the means for fixing the two molds can simultaneously make the space on each of both sides of the molded article, and that the exhaust means and the means for introducing the gas can operate on the space made on each of both sides of the molded article.

The injection molding apparatus with a plasma generator according to the fifth aspect of the present invention is characterized in that the microwave antenna is constituted of a slot antenna in which slots are filled with a dielectric material. In this case, preferably, the slots are each filled with a dielectric material, or the front surface of the slot antenna is covered with a dielectric plate, or both of these items are executed. With this arrangement, the antenna front surface that has been made a smoothed surface can constitute the molding surface of the molded article, together with other cavity surfaces of the molds. This prevents slot patterns from being projected onto the molding surface.

The injection molding apparatus with a plasma generator according to the sixth aspect of the present invention is characterized in that the microwave antenna is constituted of a microstrip antenna sandwiched between two dielectric plates, and that, during molding, the microwave antenna constitutes a molding surface of the molded article together with the molds. With this arrangement, the antenna front surface that has been made a smoothed surface can constitute the molding surface of the molded article, together with other cavity surfaces of the molds. This prevents a microstrip antenna pattern from being projected onto the molding surface.

A method for injection molding and surface processing according to the seventh aspect of the present invention includes fixing two molds, with a space made between one of the two molds and a molded article, after injection molding has been performed; exhausting air from the space to thereby hold a predetermined degree of vacuum in the space, and introducing a gas for processing the surface of the molded article, into the space. Herein, the gas is brought into a state of plasma by microwaves to thereby process the surface of the molded article.

### Advantages

According to the present invention, since plasma is generated using microwaves, either of the molds can be grounded. Also, the electric discharge using microwaves allows plasma to be easily generated in a space of about 1 mm. When there is dielectric material on a metal, the microwaves propagate along the surface of the dielectric material as surface waves, and therefore, microwave plasma can be generated along a plastic surface with a large area. This produces an especially high effect in a tabular plastic molded article, thereby facilitating surface processing with respect to a plastic plate having a large area. Also, because the microwave plasma has a low ion energy, damage by plasma to the surface does not occur. As described above, the present invention can solve the foregoing problem associated with high-frequency discharge.

### BRIEF DESCRIPTION OF THE DRAWINGS

FIG. 1 is a sectional view showing the configuration and the usage of an injection molding and surface processing apparatus 1000 according to a specific embodiment of the present invention.

FIG. 2 is a diagram showing the configurations of microwave antennas.

FIG. 3A is a sectional view of the configuration and the usage of an injection molding and surface processing apparatus 2000 according to a second embodiment of the present invention.

FIG. 3B is a sectional view of the configuration and the usage of an injection molding and surface processing apparatus 2000 according to the second embodiment.

FIG. 3C is a sectional view of the configuration and the usage of an injection molding and surface processing apparatus 2000 according to the second embodiment.

FIG. 4A is a sectional view of the configuration and the usage of an injection molding and surface processing apparatus 2100 according to a third embodiment of the present invention.

FIG. 4B is a sectional view of the configuration and the usage of an injection molding and surface processing apparatus 2100 according to the third embodiment.

FIG. 4C is a sectional view of the configuration and the usage of an injection molding and surface processing apparatus 2100 according to the third embodiment.

FIG. 4D is a sectional view of the configuration and the usage of an injection molding and surface processing apparatus 2100 according to the third embodiment.

### REFERENCE NUMERALS

1000: injection molding and surface processing device
100: first mold
120: jack
130: gas supply portion
131: gas inlet pipe
132 and 132a: gas inlet ports
140: exhaust device
141: exhaust pipe
142 and 142b: exhaust outlets
150: waveguide
160: microwave antenna
161: slot
200: second mold
201: O-ring
300: resin injector

### DESCRIPTION OF THE PREFERRED EMBODIMENTS

For example, as microwave antennas, a large number of slot antennas can be used. By uniformly irradiating microwaves over a large area, high-density plasma with a uniform distribution can be generated. As microwave antennas, stripline antennas with branch may be used.

A plurality of gas introduction places may be used. Thereby, a reaction gas is uniformly dispersed, and radical distribution can be uniformalized, which allows surface modification ensuring an improved uniformity to be performed.

Hereinafter, embodiments that have implemented the present invention are described. However, the present invention is not limited to the embodiments described below; the embodiment thereof can be variously modified.

### First Embodiment

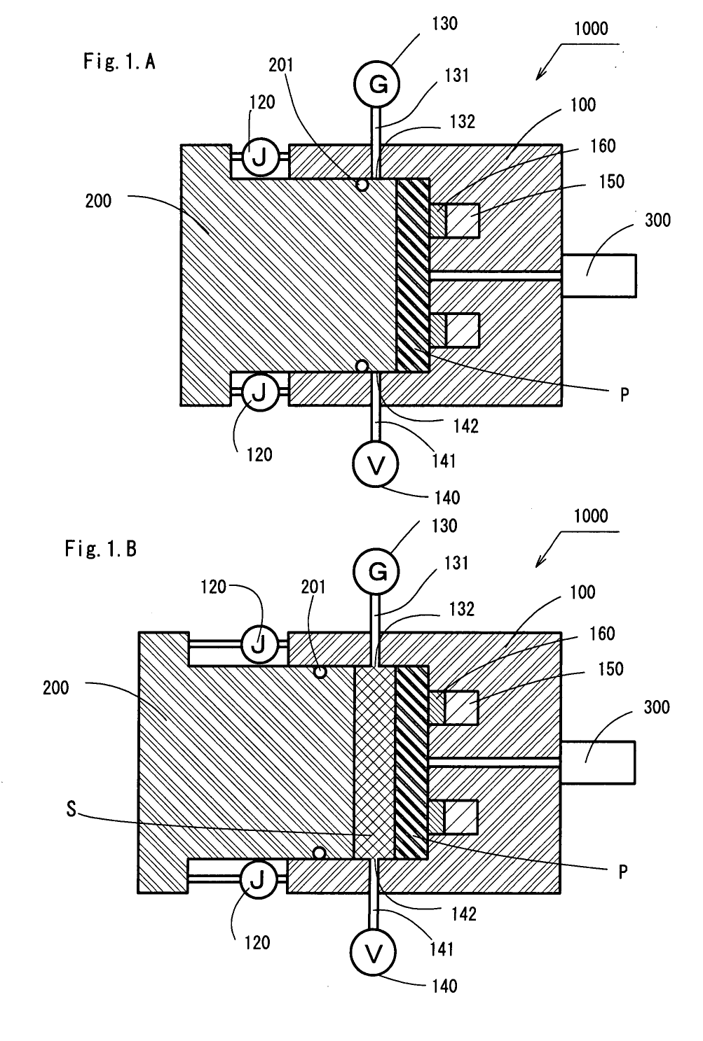

FIG. 1 is a sectional view of the configuration and the usage of an injection molding and surface processing apparatus 1000 according to a specific embodiment of the present invention. The injection molding and surface processing apparatus 1000 includes a first mold 100, a second mold 200, and a resin injector 300. Furthermore, the injection molding and surface processing apparatus 1000 includes a jack 120 (this constitutes fixing means) that fixes the first mold 100 and the second mold 200 in predetermined positions; a gas supply portion 130 for introducing a gas from a gas inlet port 132 of the first mold 100 into the space, and a gas inlet pipe 131 (these constitute gas introducing means); and an exhaust pipe 141 for exhausting air in the space from an exhaust outlet 142 of the first mold 100, and an exhaust device 140 (these constitute exhaust means). Waveguides 150 are buried in the injection molding surface of the first mold 100, and each connected to a microwave antenna 160. Each of the waveguides 150 is a rectangular parallelepiped-shaped waveguide extended in the direction perpendicular to the plane of the figure. Microwaves are supplied to the waveguides 150 from the direction on the surface side of the plane of the figure, or from the direction on the back side thereof. Each of the microwave antennas 160 is constituted of a metal plate having a slot antenna, and electromagnetically coupled to one surface of a respective one of the waveguides 150. Because the microwave antennas 160 are integrally provided on the injection molding surface of the first mold 100, and the slot portions thereof are filled with a dielectric material as in the case of the waveguides 150, the injection molding surface is free of irregularities. The second mold 200 has an O-ring 201, which allows the space formed between the second mold 200 and the first mold 100 to be kept airtight.

First, as shown in FIG. 1A, an ordinary injection molding is performed, and a molded article P is cooled to solidify. At this time, the gas inlet port 132 and the exhaust outlet 142 are blocked by the second mold 200. Next, as shown in FIG. 1B, the second mold 200 is moved by 1 to several millimeters using the jack 120, to thereby form a space S between the second mold 200 and the molded article P. Here, the gas inlet port 132 and the exhaust outlet 142 open with respect to the space S due to the movement of the second mold 200, so that the gas inlet pipe 131, the space S, and the exhaust pipe 141 communicate with one another.

These gas inlet pipe 131, space S, and exhaust pipe 141 are made airtight by the O-ring 201 of the second mold 200. Then, from the airtight space S, air is exhausted using the exhaust device 140. Next, a gas for plasma processing is supplied from the gas supply portion 130 into the space S. For surface processing, a gas suited to carbon coating is desirable. Thereafter, upon supply of microwaves to the microwave antennas 160 via the waveguides 150, an electric discharge by the microwaves occurs and gas plasma occurs, in the space S. After processing for a desired time period, the supply of the microwaves and the supply of the reactive gas are stopped. Then, after the space S has been returned to the atmospheric pressure, the molds are opened and the molded article P is taken out.

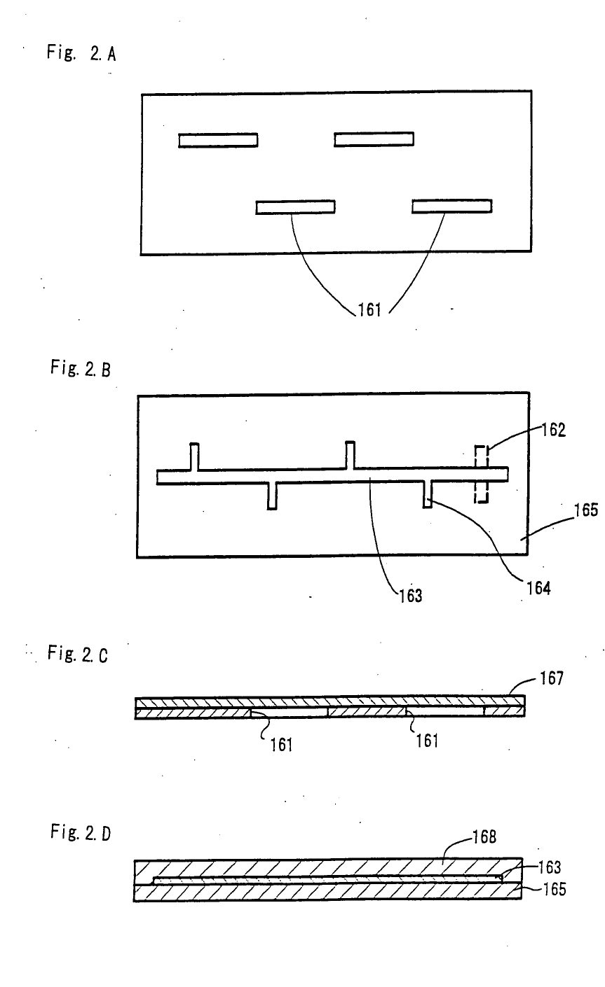

As the microwave antenna, for example, it is recommendable that a slot antenna as shown in FIG. 2A is used. In this case, each of the waveguides 150 can be formed into a rectangular shape, and each of slot antennas can be provided on one surface of a respective one of the waveguides 150. Also, as in the case of the waveguides 150, it is advisable that the slots 161 are filled with a dielectric material so that the antenna surfaces are free of unwanted irregularities. Furthermore, as shown in a sectional view in FIG. 2C, it is desirable to cover the entire surfaces of the slot antennas in contact with the plastic molded article with a dielectric material 167 so as to prevent the shapes of the slot antennas from being projected onto the molded surface of the molded article. Elongating each of the waveguides, or increasing the number of the waveguides to thereby provide a large number of slots 161, allows a plasma generation region to be expanded up to several meters square. It is recommendable that waveguides in a TE100 mode are used as the waveguides 150. Thereby, microwaves with an equal power can be radiated from each slot, and uniform and high-density plasma can be generated over a wide area.

Also, a microstrip antenna as shown in FIG. 2B may be used. This microstrip antenna is a laminate constituted of a grounding plate (not shown) and a dielectric substrate 165. The grounding plate has a coupler 162 (shown by a broken line) constituted of a slot, and arranged for the coupling to the 150. On the dielectric substrate 165, there are provided a trunk line 163 and branch-shaped antenna element portions 164, to form a microstrip antenna. As shown in a sectional view in FIG. 2D, it is advisable to eliminate irregularities on the surface, and further to entirely cover the trunk line 163 and the antenna element portions 164 with a dielectric plate 168 so as to prevent the shape of the microstrip antenna from being projected onto the molded surface of the molded article.

It is recommendable to provide a metal mesh in a desired position of each of the gas inlet pipe 131 and the exhaust pipe 141 to shield electromagnetic waves. Also, the gas inlet pipe 131 and the exhaust pipe 141 may constitute a cut-off waveguide to shield electromagnetic waves.

In the above-described embodiment, air in the space S alone is exhausted, but the entirety of the injection molding and surface processing apparatus 1000 may be disposed in a vacuum room.

In the above-described embodiment, the waveguides 150 and the microwave antennas 160 are provided in the first mold 100 with the resin injector 300, but the waveguides 150 and the microwave antennas 160 may also be provided in the second mold 200, or they may be provided in each of both the first mold 100 and the second mold 200. Furthermore, an injection molding and surface processing apparatus may be formed of two molds and a frame-shaped mold having a resin injector, to thereby plasma-process both surfaces of the resin molded article at a time. In this case, for the plasma processing with respect to both surfaces of the resin molded article, either the same gas or mutually different gases may be used.

### Second Embodiment

By somewhat changing the configuration shown in FIG. 1, both surfaces of the molded article P can be plasma-processed. This is because, if the thickness of the molded article P is on the order of 1 cm, the gas across the molded article P from the antennas can be brought into a plasma state by microwaves.

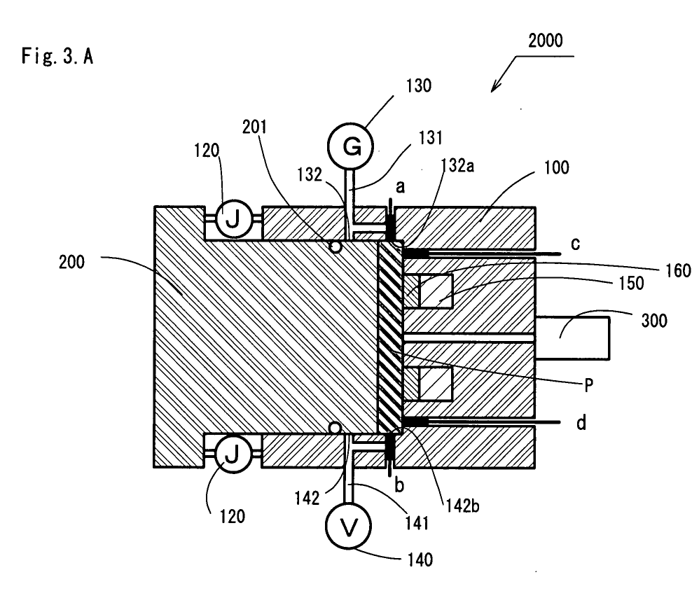

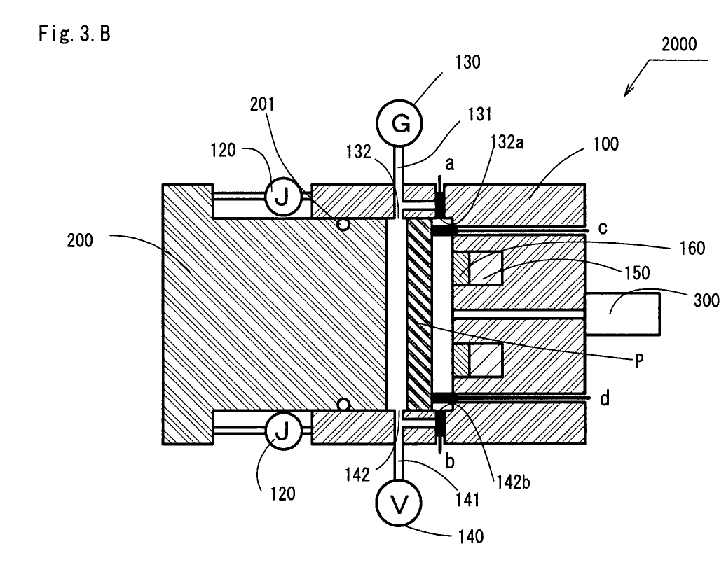

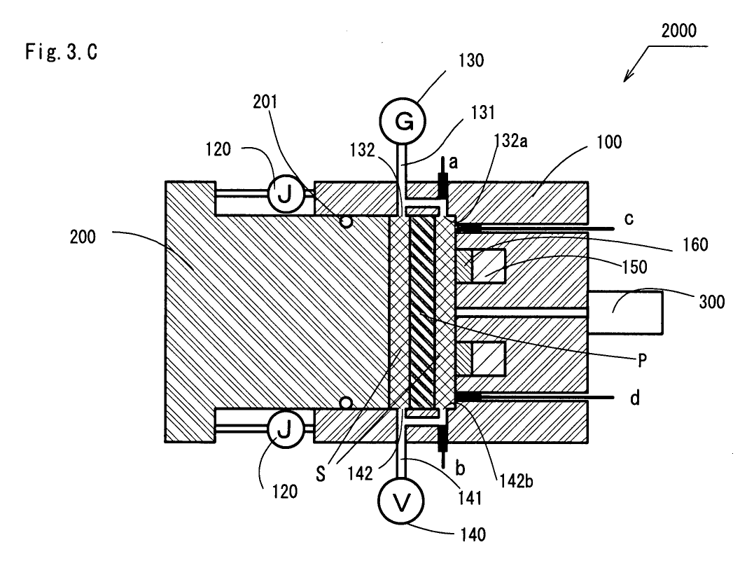

First, with reference to FIG. 3A to FIG. 3C, description is made of the configuration and the usage of an injection molding and surface processing apparatus 2000 that simultaneously plasma-processes both surfaces of the molded article P. As shown in FIG. 3A, the configuration of the injection molding and surface processing apparatus 2000 differs from that of the injection molding and surface processing apparatus 1000 in FIG. 1A. in that the gas inlet pipe 131 and the exhaust pipe 141 are caused to communicate also with a gas inlet port 132a and an exhaust outlet 142b that are provided slightly to the right inside the injection molding apparatus. Here, the gas inlet port 132a and the exhaust outlet 142b that are provided slightly to the right inside the injection molding apparatus have levers a and b, respectively, that are configured to switch the communication/non-communication with the gas supply portion 130 and the exhaust device 140. The surfaces of the levers a and b are adapted to be in contact with the injection molded article. Furthermore, there are provided push arms c and d to allow the molded article to move, whereby a space can be provided also between the molded article P and the first mold 100 after injection molding.

First, as shown in FIG. 3A, injection molding is performed. The gas inlet port 132 and the exhaust outlet 142 are blocked by the second mold 200. The gas inlet port 132a and the exhaust outlet 142b are blocked by the levers a and b. The surfaces of the levers a and b make contact with the molded article, the contact surface therebetween having no irregularities. Likewise, the surfaces of the push arms c and d make contact with the molded article, the contact surface therebetween having no irregularities.

Next, as shown in FIG. 3B, the second mold 200 is moved to the left by a predetermined amount on the plane of the figure. Also, the molded article P is moved to the left by a predetermined amount using the push arms c and d, to thereby form the spaces S on both lateral sides of the molded article P.

Then, the push arms c and d are returned to the predetermined positions, and the levers a and b are actuated to cause to communicate the gas inlet pipe 131, the gas inlet port 132a, the exhaust outlet exhaust outlet 142b, and the exhaust pipe 141 with one another, via the space S on the right side of the molded article P. On the other hand, the gas inlet port 132 and the exhaust outlet 142 communicate with each other via the space S on the left side of the molded article P, the space S having been formed by the movement of the second mold 200.

Thereafter, from the airtight spaces S on both sides, air is exhausted using the exhaust device 140, and a gas for plasma processing is supplied from the gas supply portion 130 into the spaces S on both sides (FIG. 3C). Then, upon supply of microwaves to the microwave antennas 160 via the waveguides 150, an electric discharge by the microwaves occurs and simultaneously gas plasma occurs, in the spaces S on both sides of the molded article P. After processing for a desired time period, the supply of the microwaves and the supply of the reactive gas are stopped. Then, after the spaces S on both sides have been returned to the atmospheric pressure, the molds are opened and the molded article P is taken out.

The spaces S provided on the left and right sides may have widths different from each other depending on setting.

### Third Embodiment

By somewhat changing the configuration shown in FIG. 3A, both surfaces of the molded article P can be separately plasma-processed.

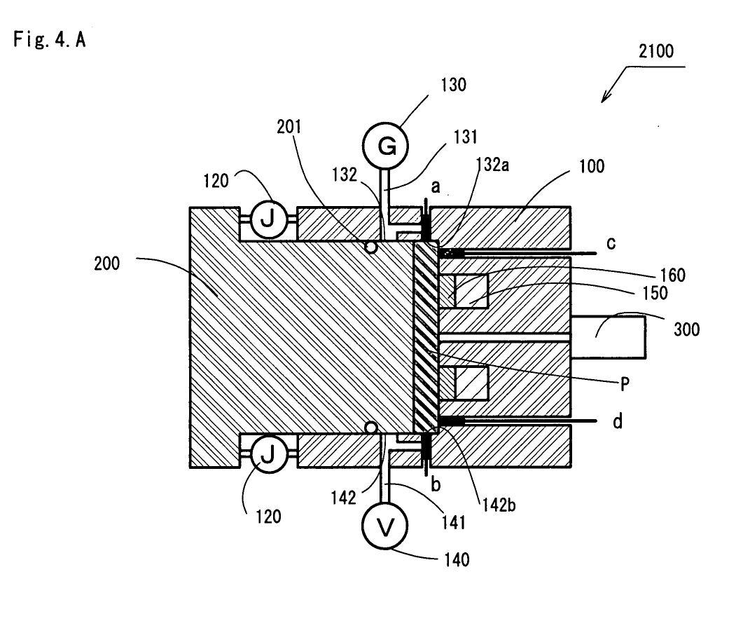

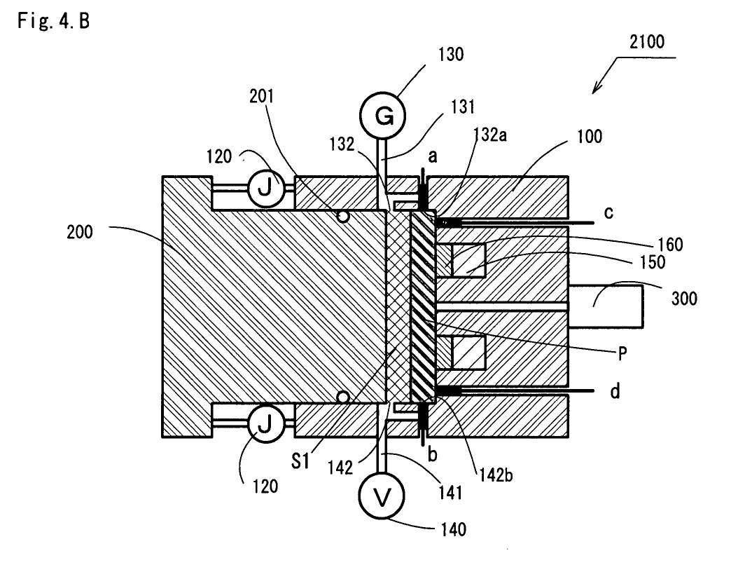

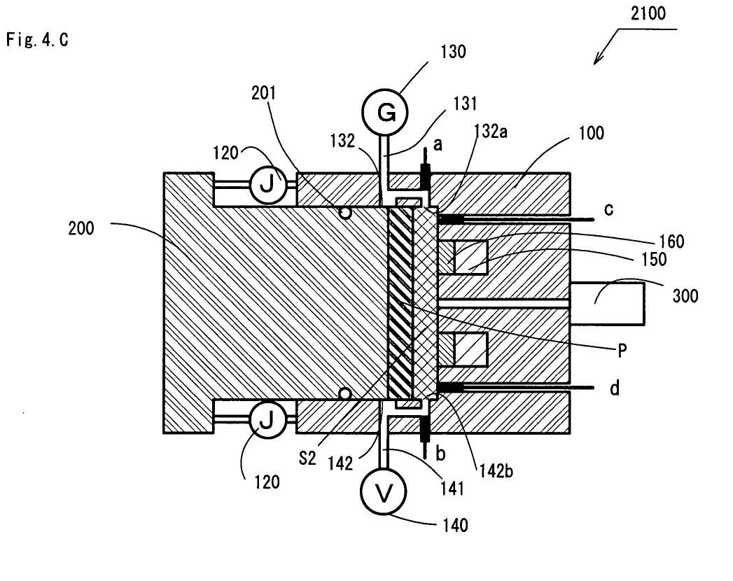

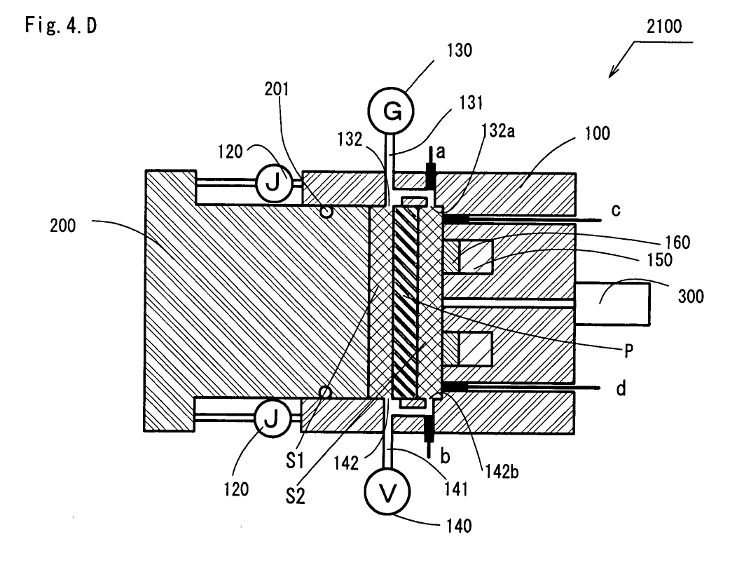

First, with reference to FIG. 4A to FIG. 4C, description is made of the configuration and the usage of an injection molding and surface processing apparatus 2100 that sequentially plasma-processes both surface of the molded article P. As shown in FIG. 4A, the configuration of the injection molding and surface processing apparatus 2100 differs from that of the injection molding and surface processing apparatus 2000 in FIG. 3A. in that the installation positions of the gas inlet port 132 and the exhaust outlet 142 have been changed. As in the case of the injection molding and surface processing apparatus 2000 in FIG. 3A, the injection molding and surface processing apparatus 2100 also has the gas inlet port 132a and the exhaust outlet 142b that are provided slightly to the right inside the injection molding apparatus.

First, as shown in FIG. 4A, injection molding is performed. The gas inlet port 132 and the exhaust outlet 142 are blocked by the second mold 200. The gas inlet port 132a and the exhaust outlet 142b are blocked by the levers a and b. The surfaces of the levers a and b make contact with the molded article, the contact surface therebetween having no irregularities. Likewise, the surfaces of the push arms c and d make contact with the molded article, the contact surface therebetween having no irregularities.

Next, as shown in FIG. 4B, the second mold 200 is moved to the left by a predetermined amount on the plane of the figure. As a result, a space S1 is formed on the left side of the molded article P, via which the gas inlet pipe 131, the gas inlet port 132, the exhaust outlet 142, and the exhaust pipe 141 are communicated with one another. Then, air exhaust is performed using the exhaust device 140, and a gas for plasma processing is supplied from the gas supply portion 130 into the space S1 on the left side. Thereafter, upon supply of microwaves to the microwave antennas 160 via the waveguides 150, an electric discharge by the microwaves occurs and gas plasma occurs, in the space S1 on the left side of the molded article P.

After processing for a desired time period, the supply of the microwaves and the supply of the reactive gas are stopped. Then, as shown in FIG. 4C, the molded article P is moved to the left side by the push arms c and d, to thereby form a space S2 on the right side of the molded article P. In this case, the molded article P may be moved after the space S1 on the left side has been returned to the atmospheric pressure. Also, the width of the space S2 to be formed on the right side of the molded article P may be different from that of space S1 that has been provided on the left side of the molded article P, by laterally moving the second mold 200 by a predetermined amount.

Thus, the space S1 on the left side of the molded article P disappears, and the space S2 is formed on the right side. Due to the disappearance of the space S1 on the left side of the molded article P, the gas inlet port 132 and the exhaust outlet 142 is blocked by the second mold 200 and the molded article P. Conversely, the gas inlet pipe 131, the gas inlet port 132a, the exhaust outlet 142b, and the exhaust pipe 141 are communicated with one another, via the space S2 on the right side of the molded article P (FIG. 4C). Then, air exhaust is performed using the exhaust device 140, and a gas for plasma processing is supplied from the gas supply portion 130 into the space S2 on the right side. Thereafter, upon supply of microwaves to the microwave antennas 160 via the waveguides 150, an electric discharge by the microwaves occurs and gas plasma occurs, in the space S2 on the right side of the molded article P. After processing for a desired time period, the supply of the microwaves and the supply of the reactive gas are stopped. Then, after the space S2 on the right side have been returned to the atmospheric pressure, the molds are opened and the molded article P is taken out.

As shown in FIG. 4D, the injection molding and surface treating apparatus 2100 in FIG. 4A allows both sides of the molded article P to be simultaneously plasma-processed. The width of each of the spaces S1 and S2 on both sides may be different depending on design.

1. An injection molding apparatus with a plasma generator, comprising:
means for fixing two molds, with a space made between one of the two molds and a molded article, after injection molding has been performed;
at least one waveguide formed in at least one of the two molds;
a microwave antenna that is connected to the at least one waveguide and that radiates microwaves into the space;
exhaust means that exhausts air from the space to thereby hold a predetermined degree of vacuum in the space; and
means for introducing a gas for processing the surface of the molded article, into the space between the at least one mold and the molded article,
whereby plasma of the gas is allowed to be generated in the space.

2. The injection molding apparatus with a plasma generator according to claim 1, wherein the at least one waveguide is filled with a dielectric material.

3. The injection molding apparatus with a plasma generator according to claim 1
wherein the means for fixing the two molds can make the space on either side of the molded article; and
wherein the exhaust means and the means for introducing the gas can operate on the space made on either side of the molded article.

4. The injection molding apparatus with a plasma generator according to claim 2
wherein the means for fixing the two molds can make the space on side of the molded article; and
wherein the exhaust means and the means for introducing the gas can operate on the space made on either side of the molded article.

5. The injection molding apparatus with a plasma generator according to claim 1
wherein the means for fixing the two molds can simultaneously make the space on each of both sides of the molded article; and
wherein the exhaust means and the means for introducing the gas can operate on the space made on each of both sides of the molded article.

6. The injection molding apparatus with a plasma generator according to claim 2,
wherein the means for fixing the two molds can simultaneously make the space on each of both sides of the molded article; and
wherein the exhaust means and the means for introducing the gas can operate on the space made on each of both sides of the molded article.

7. The injection molding apparatus with a plasma generator according to claim 1, wherein the microwave antenna is constituted of a slot antenna in which slots are filled with a dielectric material.

8. The injection molding apparatus with a plasma generator according to claim 2, wherein the microwave antenna comprises a slot antenna in which slots are filled with a dielectric material.

9. The injection molding apparatus with a plasma generator according to claim 3, wherein the microwave antenna comprises a slot antenna in which slots are filled with a dielectric material.

10. The injection molding apparatus with a plasma generator according to claim 4, wherein the microwave antenna comprises a slot antenna in which slots are filled with a dielectric material.

11. The injection molding apparatus with a plasma generator according to claim 1,
wherein the microwave antenna comprises a microstrip antenna sandwiched between two dielectric plates; and
wherein, during molding, the microwave antenna constitutes a molding surface of the molded article together with the molds.

12. The injection molding apparatus with a plasma generator according to claim 2,
wherein the microwave antenna comprises a microstrip antenna sandwiched between two dielectric plates; and
wherein, during molding, the microwave antenna comprises a molding surface of the molded article together with the molds.

13. The injection molding apparatus with a plasma generator according to claim 3,
wherein the microwave antenna comprises a microstrip antenna sandwiched between two dielectric plates; and
wherein, during molding, the microwave antenna comprises a molding surface of the molded article together with the molds.

14. The injection molding apparatus with a plasma generator according to claim 4,
wherein the microwave antenna comprises a microstrip antenna sandwiched between two dielectric plates; and
wherein, during molding, the microwave antenna comprises a molding surface of the molded article together with the molds.

15. A method of injection molding and surface processing, comprising:
fixing two molds, with a space made between one of the two molds and a molded article, after injection molding has been performed; and
exhausting air from the space to thereby hold a predetermined degree of vacuum in the space, and introducing a gas for processing the surface of the molded article, into the space,
wherein the gas is brought into a state of plasma by microwaves, to thereby process the surface of the molded article.
